(19) United States
(12) Patent Application Publication
(10) Pub. No.: US 2012/0302814 A1
(43) Pub. Date: Nov. 29, 2012

(54) Stacking Apparatus and Method of Stacking

(75) Inventors: Philip Andrew Lewthwaite, Seascale (GB); Harry Elsley, Seascale (GB)

(73) Assignee: NUCLEAR DECOMMISSIONING AUTHORITY, Moor Row, Cumbria (GB)

(21) Appl. No.: 13/574,359

(22) PCT Filed: Jan. 21, 2011
(86) PCT No.: PCT/GB2011/050102

§ 371 Date: Jul. 20, 2012

(30) Foreign Application Priority Data
Jan. 22, 2010 (GB) 1001050.2

(51) Int. Cl. G21F 9/00; F16M 13/02; B09B 5/00

(52) U.S. Cl. 588/16; 588/249.5; 211/85.3

(57) ABSTRACT

The invention provides a storage device adapted for use for the storage of waste materials in a glovebox, the device comprising support means incorporating engaging means, the support means comprising a substantially hollow body and the engaging means being adapted to restrain an object therein. It is a particular advantage of the device that the support means defines a hollow interior section in the device, thereby facilitating the storage of additional waste materials integrally within the device in a safe and orderly manner. The device finds particular application in a method for the removal of waste materials located in a glovebox, wherein the waste materials comprise hazardous biological or radioactive materials. In a particularly preferred embodiment, the storage device comprises an essentially cylindrical stacker comprising a collar and, extending therefrom, three elongate members each comprising, at the distal end thereof, engaging means comprising flanges and rims which thereby defining a groove and form feet which allow the device to stand upright.

### FIELD OF THE INVENTION

The invention relates to a stacking apparatus and to a method of using this apparatus. The invention finds particular application as a device for use in gloveboxes, and has particular, but not exclusive, utility in the processing of radioactive waste.

### BACKGROUND TO THE INVENTION

It is a well known standard practice for workers skilled in the appropriate arts to conduct processing operations involving certain categories of radioactive or other toxic materials in a glovebox, which comprises a contained working environment which allows the operator to handle the toxic materials while being protected by flexible gauntlets into which arms and hands can be inserted. These gauntlets are typically made of a chemically resistant rubber type compound and are commonly referred to as ‘ambidextrous gloves’ or simply ‘gloves’. They are attached to the walls of the glovebox by means of sealing arrangement in which a bead on the glove is firmly located in a slot within an annular housing mechanism incorporated within the wall of the glovebox. The glove then protrudes through the annulus and into the glovebox.

Typically the glovebox is operated at slightly below atmospheric pressure, such that the gloves are automatically drawn into the glovebox. In this way the glovebox is completely sealed, and further protection is provided by the negative pressure, which ensures that any minor tears in the glove will result in an inward leak path to the glovebox, rather than an outward leak that would allow toxic material to exit the glovebox.

The annular opening through which the glove protrudes is typically referred to as a gloveport, and the ring to which the glove is attached may be referred to as a gloveport ring. In view of the negative pressure within the glovebox, and because of the nature of operations that may be carried out in the glovebox, it is advantageous if the glove is firmly attached to the gloveport ring.

Other such ports in the wall of the glovebox have plastic (typically PVC or polythene) bags attached, and they are used for passing waste and other materials out of the glovebox, by a process typically known as ‘bagging out’. This procedure will be familiar to those skilled in the art of glovebox operations, and it involves placing the waste into the bags, which are then sealed into discrete packages which may subsequently be detached, thereby maintaining the containment of both the detached package and the glovebox.

Items are inserted into the glovebox by a process typically known as ‘bagging in’. This procedure will also be familiar to those skilled in the art of glovebox operations, and it involves placing the item into a bag or a glove and replacing the bag or glove with a new bag or glove, such that the old bag or glove, together with the item contained therein, both pass through the gloveport and into the glovebox, whilst glovebox containment is provided by the new bag or glove.

It will be readily apparent from the above that an essential prerequisite for both bagging in and bagging out is that geometric and other considerations allow the item to pass through a port. This requirement heavily restricts the operations that can be performed in a glovebox.

In respect of the gloves which are used in conjunction with a glovebox, it is inevitable that there is a requirement for gloves to be changed on a reasonably frequent basis, as they become soiled, damaged or worn. One method of changing the gloves when they require to be renewed is to insert a new glove, ready mounted on a gloveport ring, into the gloveport, thereby displacing the old ring and glove into the glovebox. However, it will be appreciated that repeated operation of this practice results in the accumulation of redundant rings and gloves within the glove box, and these items subsequently require to be disposed of via the bagging out process previously described.

Significant problems arise as a result of this process, in that the redundant rings are difficult to store neatly, tending to form an unsteady and untidy pile which occupies valuable space within the glovebox and can become a safety hazard. Likewise, the difficulty in stacking the rings renders the bagging out process inefficient, frequently requiring that the rings either be bagged out individually, or else gathered together into bulky waste packages that are difficult to handle and further process. A further inefficiency presented by the rings in waste packages is that the annular space within each ring is empty, thereby resulting in packages which have an unnecessarily high fraction of wasted void space.

Those skilled in the art of glovebox operation will appreciate the need to ensure good housekeeping within the glovebox and will be familiar with the safety and financial benefits of minimising the number of bagging out operations and utilising all the available void space within the waste packages.

It is already known to crush or break such objects in order to reduce the voidage in waste packages. Such a process, however, requires either a substantial press or similar, which is expensive and difficult to install and operate in a glovebox environment, or a simpler mechanical operation which can result in the formation of sharp fragments, and these are clearly a particular hazard in a glovebox environment.

Consequently, the present invention seeks to alleviate, at least partially, some or any of these problems.

### SUMMARY OF THE INVENTION

Thus, in accordance with a first aspect of the present invention there is provided a storage device adapted for use for the storage of waste materials in a glovebox, said device comprising support means incorporating engaging means, said support means comprising a substantially hollow body and said engaging means being adapted to restrain an object therein.

It is a particular advantage of the said device that said support means defines a hollow interior section in said device, thereby facilitating the storage of additional waste materials integrally within said device in a safe and orderly manner. Thus, the invention provides a means for the convenient and efficient minimisation of the volume of waste material.

Preferably, said object comprises a ring. Particularly preferably, the storage device according to the first aspect of the invention is used for the storage of waste materials, more preferably hazardous waste materials. Most preferably, said ring comprises a gloveport ring for mounting a glove in a glovebox. Typically, said gloveport ring may be a redundant gloveport ring which is no longer required for mounting of gloves.

Preferably, said support means comprises a frame comprising an external surface adapted to engage with a ring.

More preferably, said support means comprises essentially cylindrical support means. Most preferably, said essentially cylindrical support means comprises a collar and, extending therefrom, a plurality of elongate members having a support surface, wherein said elongate members define a hollow interior section in said device.

In particularly preferred embodiments, said engaging means are located at the ends of said elongate members distant from said collar. It is especially preferred that said engaging means should be comprised in said elongate members. Preferably separate engaging means are disposed on each of said elongate members. In alternative embodiments of the invention, however, a single engaging means may extend around the full circumference of said storage device.

Preferably, said engaging means comprises a flange and a rim defining a groove in said flange, and adapted to restrain an object in said groove. In said embodiment, it is preferred that said rim has a diameter which is greater than that of said elongate members, such that objects coming into contact with said rim are prevented from moving externally of said storage device.

In preferred embodiments, said elongate members are equispaced around said collar so that, in use, they provide maximum stability for said storage device. Preferably, said device comprises three elongate members.

Optionally, said support means may comprises solid cylindrical support means, wherein the collar and elongate members are effectively one and the same item. In said embodiments, said engaging means may comprise discrete engaging means equispaced around said device or, more preferably, may comprise a single engaging means extending around the full circumference of said storage device.

Preferably, said device according to the first aspect of the invention comprises a polymer material. More preferably, said polymer material comprises a polyalkene, most preferably polypropylene.

The device according to the first aspect of the invention is preferably used in gloveboxes utilised for the handling of hazardous materials. Accordingly, in such applications, it is important that the dimensions of the device are such that it is able to enter the glovebox by being posted through the ports of said gloveboxes. Thus, in preferred embodiments, the diameter of the collar is less than the diameter of said ports, and this criterion is met when the device is posted in through waste posting ports, which typically have a diameter of at least 20.32 cm (8 inches). It is, however, most beneficial if the flexibility of the elongate members of the storage device is such that the device is able to enter the glovebox by means of being posted through a gloveport, which conventionally has a diameter of approximately 15.24 cm (6 inches). The selection of polyalkenes as the material of construction of the devices ensures that these flexibility criteria are met.

According to the second aspect of the present invention, there is provided a method for the removal of waste materials located in a glovebox, said method comprising the steps of:
(a) inserting the device of the first aspect of the invention into a glovebox through a port;
(b) stacking used gloveport rings located in said glovebox around the external perimeter of said device so as to load the device and define a hollow central section of said device;
(c) placing other waste materials in said hollow central space such that they are firmly held in place between the elongate members; and
(d) removing said loaded device and waste materials from said glovebox through a port.

Insertion of the device into the glovebox may be effected by posting the device through either a glove port or a waste exit port. Preferably, removal of the device from the glovebox is effected via passing the device and associated waste gloveport rings and other materials through a waste exit port.

Generally, the waste materials found in said gloveboxes comprise hazardous material, such as biological or radioactive materials. In the latter case, said radioactive materials may include substances that emit alpha-particles such as, but not limited to, plutonium or plutonium compounds or solutions, which are routinely handled in gloveboxes, and mixtures of plutonium and uranium oxides, which are encountered as part of the process of manufacturing nuclear fuel.

### BRIEF DESCRIPTION OF THE DRAWINGS

Embodiments of the invention are further described hereinafter with reference to the accompanying drawings, in which:

FIG. 1 is a 3-dimensional view-section of a device according to a preferred embodiment of the first aspect of the invention; and

FIG. 2 is a side elevation of a device according to a preferred embodiment of the first aspect of the invention.

FIG. 3 is a side elevation of engaging means in a device according to a preferred embodiment of the first aspect of the invention.

### DETAILED DESCRIPTION OF THE INVENTION

The present invention provides a device which is a simple, yet extremely effective, free-standing system on which used gloveport rings can be easily stacked, and the associated waste placed inside in a neat and orderly fashion, thereby maintaining good housekeeping and safety standards within gloveboxes. It should be understood that the rings being stacked are redundant because of the nature of operations being carried out in the glovebox and are also to be removed as waste materials.

The device facilitates the posting of multiple gloveport ring stackers through conventional six-inch ports into gloveboxes simultaneously, thereby reducing posting operations.

Furthermore, glovebox ring stackers comprising devices according to the invention create packages of a uniform structure which can be stacked in a tidy manner, thereby maximising the use of all available space in waste drums into which the devices are placed after use and making subsequent storage much more cost effective. Thus, by utilising the device according to the invention, it is found that 24 such packages can fit into a standard 200 litre drum, as opposed to the current average of 12 waste packages of loose rings per drum, thus leading to a significant improvement in the utilisation of space in waste drums.

In a particularly preferred embodiment of the invention, there is provided a storage device comprising a collar and, extending therefrom, three elongate members each comprising, at the end of said member distant from said collar, engaging means comprising a flange and a rim defining a groove in said flange, wherein said device is formed of polypropylene.

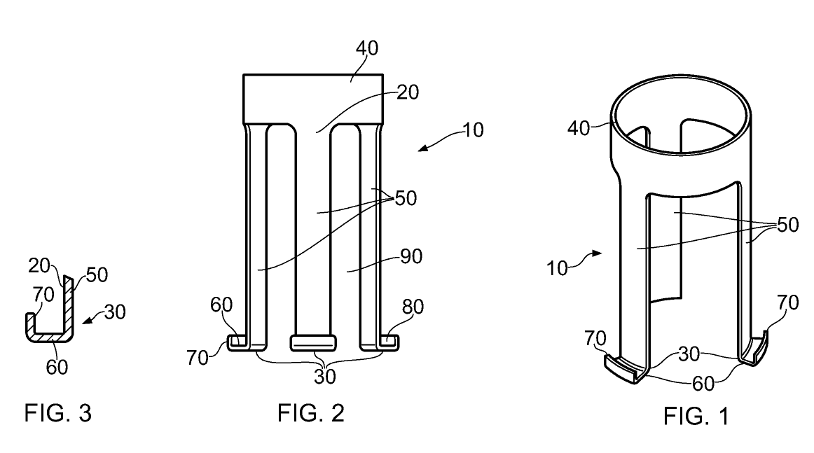

Referring now to the drawings, there is shown in FIG. 1 a general view of a storage device according to a preferred embodiment of the invention, the device comprising an essentially cylindrical stacker 10 incorporating a collar 40 and three elongate members 50, at the distal end of which are located engaging means comprising flanges 60 and rims 70 which thereby form feet 30 which allow the device to stand upright.

Turning now to the side-elevation shown in FIG. 2, there can be seen stacker 10 having an outer surface 20, preferably cylindrical, which is capable of standing on three equidistant feet 30. The stacker comprises a collar 40 from which extend three elongate members 50. At the distal end of each elongate member is a flange 60 extending radially outwards from the outer surface 20 of each elongate member 50. Each flange 60 is provided with an annular rim 70 whose inner circumference is greater than that of the outer surface 20. The rim is generally parallel to the outer surface 20 and extends back towards the collar 40. The rim 70 therefore defines a channel 80 into which the rings will be stacked.

Referring finally to FIG. 3, there is provided a closer illustration of one of the feet 30, showing the flange 60 extending radially outwards from the outer surface 20 of the distal end of elongate member 50, and the annular rim 70 provided on flange 60, and having an inner circumference greater than that of the outer surface, so as to define the channel into which the rings will be stacked.

In use, the rings are secured within the channel 80 of the stacker 10 and thereby define a central hollow portion 90 in the stacker 10. This portion 90 is capable of storing various types of waste that require removal from the glovebox but would otherwise require some other form of removal. The user thereby effectively creates a waste container by stacking the rings onto the stacker 10.

As previously discussed, the material of construction of the storage device of the invention is such that the elongate members are flexible in isolation. However, when fully loaded with rings the whole structure gains rigidity, thereby allowing the rings to be stacked and handled as a discrete assembly. Further, the elongate members, combined with the rings, form a tubular cavity which is then available as a holder for waste, for instance redundant gloves, which can be pressed into the void.

The flexibility of the elongate members allows the unused device to be bagged into the glovebox though a gloveport of the same dimensions of the rings that it subsequently stacks. Typically, this procedure is carried out as part of the glove change process that generates the waste rings and several devices may be stacked together, one inside another, for insertion into a glovebox in a single operation.

The storage device according to the invention provides several advantages in respect of the established procedures for the removal of waste from gloveboxes, as follows:
Personnel are no longer required to handle individual gloveport rings or other incidental pieces of waste;
The storage device, when fully loaded with gloveport rings, effectively becomes a container for storage and removal of other types of waste;
The storage device, typically consisting of a polymer such as polypropylene, can be lightweight and insubstantial as rigidity is supplied by the rings when in use and, consequently, does not significantly contribute to the overall waste within the glovebox.
The versatility of the material used in the manufacture of the device allows for the manufacture of varying sizes of stackers for different size gloveports, including 6 inch ports and 8 inch ports.
The storage device may be posted into a glovebox through a port that is the same size as the rings that it is designed to stack; furthermore, several devices can be inserted into each other and inserted together in one bagging-in operation.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-30. (canceled)

31. A storage device adapted for use for the storage of waste materials in a glovebox, said device comprising support means incorporating engaging means, said support means comprising a substantially hollow body and said engaging means being adapted to restrain an object therein, wherein said object comprises a gloveport ring for mounting a glove in a glovebox.

32. A storage device as claimed in claim 31 wherein said support means defines a hollow interior section in said device.

33. A storage device as claimed in claim 31 wherein said support means comprises a frame comprising an external surface adapted to engage with a ring.

34. A storage device as claimed in claim 31 wherein said support means comprises essentially cylindrical support means.

35. A storage device as claimed in claim 34 wherein said essentially cylindrical support means comprises a collar and, extending therefrom, a plurality of elongate members having a support surface, wherein said elongate members define a hollow interior section in said device, wherein said engaging means are optionally located at the ends of said elongate members distant from said collar.

36. A storage device as claimed in claim 35 wherein said engaging means are comprised in said elongate members.

37. A storage device as claimed in claim 35 wherein separate engaging means are disposed on each of said elongate members.

38. A storage device as claimed in claim 35 wherein a single engaging means extends around the full circumference of said storage device.

39. A storage device as claimed in claim 35 wherein said engaging means comprises a flange and a rim defining a groove in said flange, and adapted to restrain an object in said groove.

40. A storage device as claimed in claim 39 wherein said rim has a diameter which is greater than that of said elongate members, such that objects coming into contact with said rim are prevented from moving externally of said storage device.

41. A storage device as claimed in claim 35 wherein said elongate members are equispaced around said collar.

42. A storage device as claimed in claim 35 wherein said device comprises three elongate members.

43. A storage device as claimed in claim 34 wherein said essentially cylindrical support means comprises solid cylindrical support means, wherein the collar and elongate members are one and the same item, wherein said engaging means optionally comprises either discrete engaging means equispaced around said device or a single engaging means extending around the full circumference of said storage device.

44. A storage device as claimed in claim 31 which comprises a polymer material, wherein said polymer material optionally comprises a polyalkene, wherein said polyalkene optionally comprises polypropylene.

45. A storage device as claimed in claim 31 which is used for the storage of waste materials.

46. A storage device as claimed in claim 31 which comprises an essentially cylindrical stacker comprising a collar and, extending therefrom, three elongate members each comprising, at the distal end thereof, engaging means comprising flanges and rims which thereby defining a groove and form feet which allow the device to stand upright.

47. A method for the removal of waste materials located in a glovebox, said method comprising the steps of:
(a) inserting a device as claimed in claim 31 into a glovebox through a port;
(b) stacking used gloveport rings located in said glovebox around the external perimeter of said device so as to load the device and define a hollow central section of said device;
(c) placing other waste materials in said hollow central space such that they are firmly held in place between the elongate members; and
(d) removing said loaded device and waste materials from said glovebox through a port.

48. A method as claimed in claim 47 wherein the port used for insertion of said device into said glovebox in step (a) is a glove port or a waste exit port.

49. A method as claimed in claim 47 wherein said port used for removal of said device from said glovebox in step (d) is a waste exit port.

50. A method as claimed in claim 47 wherein said waste materials comprise hazardous materials, wherein said hazardous materials optionally comprise biological or radioactive materials, wherein said radioactive materials optionally comprise plutonium or plutonium compounds or solutions, or mixtures of plutonium and uranium oxides.
